(19) United States
(12) Patent Application Publication
(10) Pub. No.: US 2012/0062132 A1
(43) Pub. Date: Mar. 15, 2012

(54) Regulated Voltage Protection Circuit, Display Controller and LED Driving Method of the Same

(75) Inventors: Song-Yi Lin, Hsinchu Country (TW); Hsuan-I Pan, Hsinchu Country (TW); Hung I Wang, Hsinchu Country (TW)

(73) Assignee: MStar Semiconductor, Inc., Hsinchu Hsien (TW)

(21) Appl. No.: 13/152,418

(22) Filed: Jun. 3, 2011

(30) Foreign Application Priority Data
Sep. 13, 2010 (TW) 099130937

(51) Int. Cl. H05B 37/02

(52) U.S. Cl. 315/193

(57) ABSTRACT

A regulated voltage protection circuit includes a bias-voltage generating circuit and a clamping circuit. The bias-voltage generating circuit provides a bias-voltage. The clamping circuit is coupled to a plurality of light-emitting diode (LED) strings and a driving circuit, and generates a plurality of clamped voltages that are respectively transmitted to a plurality of input pads of the driving circuit according to the bias-voltage. The regulation voltage protection circuit protects against electrical overstress (EOS) by protecting the driving circuit during low-voltage fabrication process chip manufacturing.

### CROSS REFERENCE TO RELATED PATENT APPLICATION

This patent application is based on Taiwan, R.O.C. patent application No. 099130937 filed on Sep. 13, 2010.

### FIELD OF THE INVENTION

The present invention relates to a regulated voltage protection circuit, and more particularly, to a regulated voltage protection circuit of a light-emitting diode (LED) driving module.

### BACKGROUND OF THE INVENTION

Since an LED has numerous advantages, e.g., small size, short reaction time, low power consumption, high reliability, and high feasibility of mass production, the LED is widely applied to electronic apparatuses as light sources. For example, an LED serves as a backlight source of a liquid crystal display (LCD) to replace a conventional fluorescent tube.

FIG. 1 is a schematic diagram of a part of a backlight module structured by LEDs. The backlight module comprises a plurality of LED strings 10 and a driving circuit 12. Each of the LED strings 10 comprise a plurality of serially-connected LEDs 100, and an outermost LED 100 of the LED strings 10 has an anode coupled to a high voltage source V_{DC} and a cathode coupled to an input pad 14 of the driving circuit 12.

For the LED strings 10 shown in FIG. 1, when one or numerous LEDs 100 short-circuit due to invalidation, a voltage at the input pad 14 is increased. When the voltage is dramatically increased and beyond a rated voltage of the driving circuit 12, damage and invalidation are created in the driving circuit 12. Such an abnormal input voltage is so-called electrical overstress (EOS). The conventional driving circuit 12 (e.g., a driving circuit chip) is manufactured via a high-voltage fabrication process, and a chip manufactured via the high-voltage fabrication process may burden a relatively high input voltage.

However, a circuit manufactured via the high-voltage fabrication process has a larger area than that circuit manufactured via a low-voltage fabrication process, and requires higher cost during manufacture. In addition, since the high-voltage fabrication process is incompatible with the low-voltage fabrication process, the driving circuit 12 is uneasily integrated with other system circuits of an LCD. Therefore, when the driving chip manufactured via the low-voltage fabrication process is applied to an LED string of a high-voltage source, damage created in the driving circuit due to EOS needs to be prevented.

Therefore, a new regulated voltage protection mechanism is needed to protect the driving circuit 12 manufactured via the low-voltage fabrication process so as to prevent internal circuit components of the driving circuit 12 from being undesirably affected by EOS caused by a voltage from the LED strings.

### SUMMARY OF THE INVENTION

In view of the foregoing issues, according to the present invention, a regulated voltage protection circuit, applied to a LED driving module, in a driving circuit or outside a circuit chip, controls a voltage of an input pad to avoid EOS. Accordingly, the driving circuit is manufactured using a low-voltage manufacture process to integrate with other system circuits, to reduce circuit area and cost of the overall system in addition to increasing efficiency.

According to an embodiment of the present invention, the regulated voltage protection circuit provides regulated voltage protection to a driving module, which is coupled to a plurality of LED strings, and comprises a bias-voltage generating circuit and a clamping circuit. The bias-voltage generating circuit provides a bias voltage. The clamping circuit is simultaneously coupled to the plurality of LED strings and the driving module. According to the bias voltage, the clamping circuit generates a plurality of clamping voltages that are respectively transmitted to a plurality of input pads of a driving circuit.

According to another embodiment of the present invention, a display controller comprises an LED driving module comprising a plurality of LED strings, a driving circuit, a bias-voltage generating circuit, and a clamping circuit. Each of the LED strings comprises a plurality of LEDs in serial, and has one end coupled to a voltage source. The driving voltage drives the plurality of LED strings. The bias-voltage generating circuit provides a bias voltage. The clamping circuit is coupled to the plurality of LED strings and the driving circuit, and the clamping circuit generates a plurality of clamping voltages to a plurality of input pads of the driving circuit according to the bias voltage.

According to yet another embodiment of the present invention, a method for driving an LED comprises generating a bias voltage; clamping via the bias voltage a plurality of voltages from a plurality of LED strings to generate a plurality of clamped voltages; and transmitting the clamped voltages to an LED driving circuit.

### BRIEF DESCRIPTION OF THE DRAWINGS

FIG. 1 is a schematic diagram of a backlight module structured by LEDs shown in part.

FIG. 2A is a schematic diagram of a regulated voltage protection voltage in accordance with an embodiment of the present invention.

FIG. 2B is a flow chart of a method for driving LED strings in accordance with an embodiment of the present invention.

FIG. 3 is a detailed schematic diagram of the regulated protection circuit illustrated in FIG. 2A.

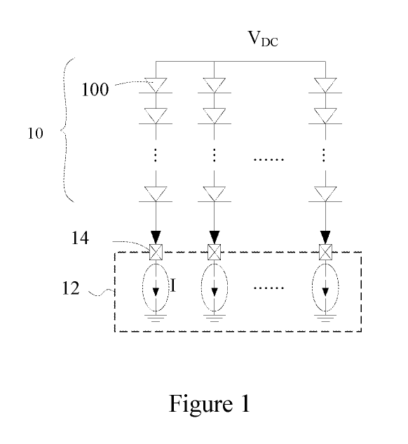

### DETAILED DESCRIPTION OF THE PREFERRED EMBODIMENT

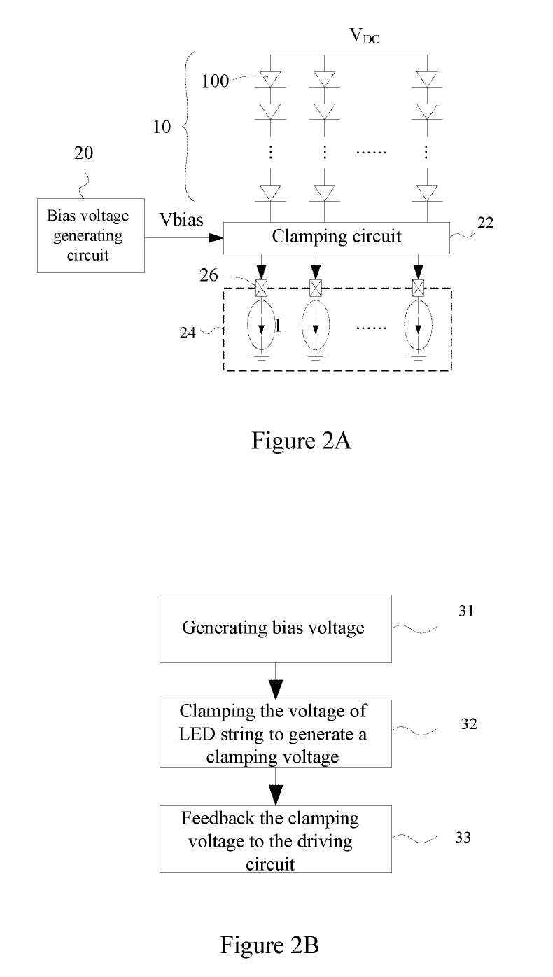

FIG. 2A shows a schematic diagram of a regulated voltage protection circuit in accordance with an embodiment of the present invention. The regulated voltage protection circuit applied to an LED driving module of a display controller protects a driving circuit of LEDs, so that internal circuit components of the driving circuit are not undesirably affected by EOS. In this embodiment, the LED driving module is a backlight module of an LCD; however, it shall not be construed as limiting the present invention. FIG. 2B is a flow chart of a method for driving an LED in accordance with an embodiment of the present invention.

In this embodiment, the regulated voltage protection circuit mainly comprises a bias-voltage generating circuit 20 and a clamping circuit 22. In Step 31, the bias-voltage generating circuit 20 provides a bias voltage V_{bias} to the clamping circuit 22, which is coupled to a plurality of LED strings 10. Each LED string includes a plurality of LEDs 100 connected in series. The outermost LED 100 of each LED string 10 has an anode coupled to a high-voltage source V_{DC}, and a cathode coupled to the clamping circuit 22. The clamping circuit 22 is further coupled to a plurality of input pads 26 of a driving circuit 24. In Step 32, the clamping circuit 22 clamps voltages at the cathodes of the outermost LEDs of the LED strings 100 to generate a plurality of clamping voltages. In Step 33, the clamping voltages are used as feedback to the input pads 26 of the LED driving circuit 24, so that a voltage at each input pad 26 is kept below a predetermined voltage or an arbitrary rated voltage, so that the driving circuit 24 is protected from being undesirably affected or damaged by electrical overstress (EOS). The predetermined (or rated) voltage is dependent on the manufacturing process of the driving circuit 24. For example, when a 5 Volt (V) manufacture process is implemented, the predetermined voltage is accordingly determined as 5V. In this embodiment, the driving circuit 24 comprises a plurality of current sources respectively controlling luminance of the LED strings 10. The driving circuit 24 is a semiconductor integrated circuit (IC) of a low-voltage manufacture process and is integrated with other system circuits of an LCD to form a system-on-chip (SOC), e.g., a display control chip.

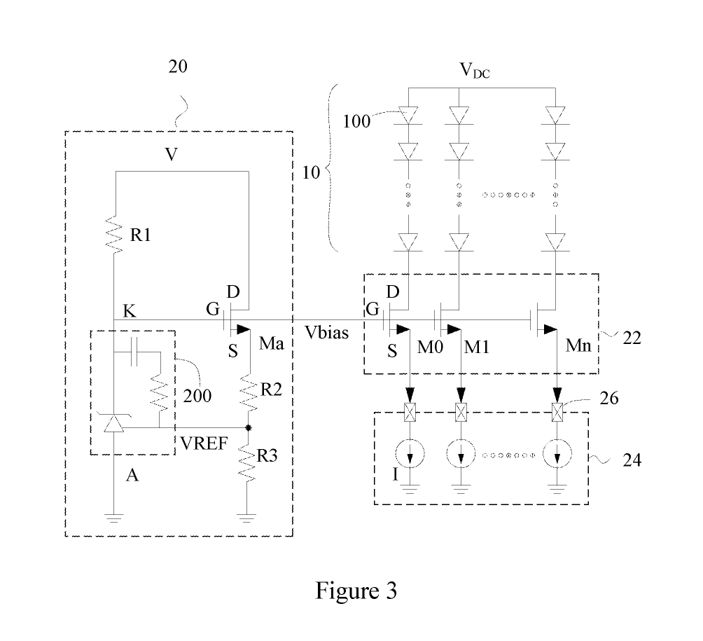

FIG. 3 shows a schematic of detailed circuits of the regulated voltage protection voltage illustrated in FIG. 2A. In this embodiment, the clamping circuit 22 comprises a plurality of parallel N-type metal-oxide-semiconductor (NMOS) clamping transistors M0, M1, . . . and Mn, which are respectively connected to LED strings 10 and input pads 16. More specifically, each clamping transistor M0/M1/Mn has a source S coupled to a corresponding input pad 26, and a drain D coupled to a cathode of the outermost LED 100 of each corresponding LED string 10. All clamping transistors M0 to Mn have gates G coupled to the bias voltage V_{bias} provided by the bias-voltage generating circuit 20. An object of the present invention is to limit the voltage at the source end S of each clamping transistor to be below a rated voltage (e.g., 5V). Thus, it is necessary to have the bias voltage generator regulate the gate voltage of the clamping transistor; also, the source voltage of the clamping transistor is controlled without being undesirably affected by variations of the drain voltage by utilizing the characteristics of a regulated voltage between a source and a gate of a clamping transistor. An approach for achieving such object is described below.

In this embodiment, the bias-voltage generating circuit 20 mainly comprises an NMOS bias-voltage transistor Ma and a regulated voltage circuit 200. The bias-voltage transistor Ma has a gate G coupled to the gates G of the clamping transistors M0 to Mn of the clamping circuit 22, a drain D electrically coupled to a voltage source V, and a source S coupled to ground via voltage-divider resistors R2 and R3. It is to be noted that, in this embodiment, the bias-voltage transistor Ma and the clamping transistors M0 to Mn share the same manufacture process, which means the bias-voltage transistor Ma and the clamping transistors M0 to Mn have the same threshold voltage. Accordingly, source voltages of the clamping transistors M0 to Mn are regulated by controlling a gate voltage and a source voltage of the bias-voltage transistor Ma. The regulated voltage circuit 200 is a programmable shunt regulator, e.g., a programmable shunt regulator TL431, which has three terminals—an anode A, a cathode K, and a reference voltage terminal V_{REF}. More specifically, the anode A is coupled to ground, the cathode K is coupled to both the gate G of the bias-voltage transistor Ma and the voltage source V via a current limiting resistor R1, and the reference voltage terminal V_{REF} is coupled to a central node of the voltage dividing resistors R2 and R3. The voltage at the gate G of the bias-voltage transistor Ma is adjusted to a desired voltage by matching the voltage source with the resistors.

Through the foregoing circuit connection configurations, a regulated voltage is generated between the gate G and the source S of the bias-voltage transistor Ma. For example, according to the design of the regulated voltage circuit, in the event that the voltage at the source S of the bias-voltage transistor Ma is 5V, the voltage at the gate G is (5+Vth)V, wherein Vth is the threshold voltage of the bias-voltage transistor Ma. Generally, the regulated voltage circuit 200 adjusts the voltage at the source S of the bias-voltage transistor Ma to be identical to a predetermined voltage of the input pads 26, and adjusts the voltage at the gate G to be equal to sum of the predetermined voltage and the threshold voltage Vth.

As mentioned above, the bias-voltage transistor Ma and the clamping transistor M0 to Mn share the same manufacture process, so that each of the clamping transistors M0, M1, and Mn has a bias voltage identical to that of the bias-voltage transistor Ma. For example, when the voltage at the gate G of the clamping transistor M0/M1/Mn is (5+Vth)V (i.e., Vth is its threshold voltage), the voltage at the source S maintains as 5V. Therefore, the configuration of the embodiment of the present invention avoids electrical overstress (EOS) of the driving circuit 24 because each voltage of the input pads 26 does not exceed the predetermined voltage (e.g., the foregoing 5V). For example, when one or several LEDs 100 of the LED strings 10 short-circuit due to component failure, the drain-source D-S voltage of the corresponding clamping transistor M0/M1/Mn is increased; however, the voltage at the source S of the clamping transistor M0/M1/Mn maintains as the predetermined voltage, protecting the driving circuit from EOS.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A regulated voltage protection circuit, for providing regulated voltage protection to a driving module coupled to a plurality of light emitting diode (LED) strings, the regulated voltage protection circuit comprising:
a bias voltage generating circuit, for providing a bias voltage; and
a clamping circuit, coupled to the plurality of LED strings and the driving module, for generating a plurality of clamping voltages according to the bias voltage and respectively transmitting the plurality of clamping voltages to a plurality of input pads of the driving module.

2. The regulated voltage protection circuit as claimed in claim 1, wherein the clamping circuit comprises a plurality of clamping transistors in parallel, connected to the LED strings and the input pads.

3. The regulated voltage protection circuit as claimed in claim 2, wherein each clamping transistor is an N-type metal-oxide-semiconductor (NMOS) transistor, having a source coupled to each input pad and a drain coupled to a cathode of an outermost LED of each LED string, and a gate coupled to the bias voltage.

4. The regulated voltage protection circuit as claimed in claim 3, wherein the bias voltage generating circuit comprises:
a bias voltage transistor, having a gate bias voltage substantially equal to the bias voltage of the clamping transistor; and
a regulated voltage circuit, comprising a predetermined voltage terminal coupled to one terminal of the bias voltage transistor, so that the bias voltage transistor generates the bias voltage, with a voltage at the predetermined voltage terminal being equal to the clamping voltages.

5. The regulated voltage protection circuit as claimed in claim 4, wherein the bias voltage transistor is a NMOS transistor, which has a gate coupled to the gates of the clamping transistors, a drain coupled to a voltage source, and a source coupled to ground via a voltage divider resistor.

6. The regulated voltage protection circuit as claimed in claim 5, further comprising a programmable shunt regulator having three terminals: an anode, a cathode, and a reference voltage terminal, wherein the anode is coupled to ground, the cathode is coupled to the gate of the bias voltage transistor and the voltage source via a current limiting resistor, and the reference voltage terminal is coupled to a central node of the voltage divider resistor.

7. The regulated voltage protection circuit as claimed in claim 1, wherein the plurality of clamping voltages are within a range from 5 Volts (5V) to 10 Volts (10V).

8. A display controller, comprising:
an LED driving module, comprising:
a plurality of LED strings, each LED string comprising a plurality of serial LEDs, one terminal of each LED string coupled to a voltage source;
a driving circuit, for driving the plurality of LED strings;
a bias-voltage generating circuit, for providing a bias voltage; and
a clamping circuit, coupled to the plurality of LED strings and the driving circuit, for generating a plurality of clamping voltages according to the bias voltage and transmitting the plurality of clamping voltages to a plurality of input pads of the driving circuit.

9. The display controller as claimed in claim 8, manufactured under a low voltage process, applied to a liquid crystal display (LCD), wherein the LED driving module drives a backlight module of the LCD.

10. The display controller as claimed in claim 8, wherein an outermost LED of the LED strings has an anode coupled to a voltage source, and has a cathode coupled to a corresponding input pad of the driving circuit via the clamping circuit.

11. The display controller as claimed in claim 8, wherein the clamping circuit comprises a plurality of parallel clamping transistors connected between the LED strings and the input pads.

12. The display controller as claimed in claim 11, wherein each clamping transistor is an NMOS transistor, having a source coupled to an input pad, a drain coupled to a cathode of an outermost LED of one LED string, and a gate coupled to the bias voltage.

13. The display controller as claimed in claim 12, wherein the bias-voltage generating circuit comprises:
a bias-voltage transistor, fabricated by the same process as the clamping transistors; and
a regulated voltage circuit, having a predetermined voltage terminal coupled to one terminal of the bias-voltage transistor, for controlling the bias-voltage transistor to generate the bias voltage, with a voltage at the predetermined voltage terminal corresponding to the plurality of clamped voltages.

14. The display controller as claimed in claim 13, wherein the bias voltage transistor is an NMOS transistor, having a gate coupled to the gates of the plurality of clamping transistors, a drain coupled to a second voltage source, and a source coupled to ground via a voltage divider resistor.

15. The display controller as claimed in claim 14, wherein the regulated voltage circuit is a programmable shunt regulator having three terminals: an anode, a cathode, and a reference voltage terminal, wherein the anode is coupled to ground, the cathode is coupled to the gate of the bias voltage transistor in addition to a second voltage source via a current limiting resistor, and the reference voltage terminal is coupled to a central node of the voltage dividing resistor.

16. The display controller as claimed in claim 8, being manufactured under a low voltage process.

17. The display controller as claimed in claim 8, wherein the driving circuit comprises a plurality of current sources for respectively driving the LED strings.

18. A method for driving an LED, comprising:
generating a bias voltage;
clamping a plurality of voltages from a plurality of LED strings via the bias voltage to generate a plurality of clamping voltages; and
transmitting the clamping voltages to a LED driving circuit manufactured under a low-voltage process.

19. The method as claimed in claim 18, further comprising:
providing the plurality of voltages to an anode of the outermost LED of each of the LED strings, wherein a cathode of the outermost LED of each LED string generates the clamping voltage.

20. The method as claimed in claim 8, wherein the LED driving circuit generates a plurality of currents for respectively driving the plurality of LED strings.
